(19) United States
(12) Patent Application Publication
(10) Pub. No.: US 2023/0061264 A1
(43) Pub. Date: Mar. 2, 2023

(54) UTILIZING A MACHINE LEARNING MODEL TO IDENTIFY A RISK SEVERITY FOR AN ENTERPRISE RESOURCE PLANNING SCENARIO

(71) Applicant: Accenture Global Solutions Limited, Dublin (IE)

(72) Inventors: Suhasish MOHANTY, Ghaziabad (IN); Anil VOHRA, Chinsurah-Mogra (IN); Arun Babu BALARAM SARMA, Bangalore (IN); Deepak SAMTANEY, Navi Mumbai (IN); Gaurav RAHEJA, Udham Singh Nagar (IN); Prakash GHORAKAVI, Bengaluru (IN); Ameya Atmaram KHANVILKAR, Dombivli (East) (IN); Savio MORAES, Mumbai (IN)

(21) Appl. No.: 17/412,857

(22) Filed: Aug. 26, 2021

(51) Int. Cl. G06Q 10/06; G06N 5/04

(52) U.S. Cl. CPC G06Q 10/06313; G06N 5/04

(57) ABSTRACT

A device may receive scenario data identifying a scenario for enterprise resource planning that includes a base solution and processes and may generate an output file based on the scenario data. The device may generate a hierarchy for the scenario based on the output file and may identify prerequisites for the scenario based on the output file. The device may generate configurations and test scripts for the scenario based on the hierarchy and the prerequisites and may retrieve, from a data structure associated with the device, master data associated with the configurations and the test scripts. The device may process the configurations, the test scripts, and the master data, with a machine learning model, to predict a risk severity associated with the scenario and may perform one or more actions based on the risk severity associated with the scenario.

### BACKGROUND

Enterprise resource planning is the integrated management of main business processes, often in real time and mediated by software and technology.

### SUMMARY

Some implementations described herein relate to a method. The method may include receiving scenario data identifying a scenario for enterprise resource planning that includes a base solution and processes and generating an output file based on the scenario data. The method may include generating a hierarchy for the scenario based on the output file and identifying prerequisites for the scenario based on the output file. The method may include generating configurations and test scripts for the scenario based on the hierarchy and the prerequisites and retrieving, from a data structure associated with the device, master data associated with the configurations and the test scripts. The method may include processing the configurations, the test scripts, and the master data, with a machine learning model, to predict a risk severity associated with the scenario and performing one or more actions based on the risk severity associated with the scenario.

Some implementations described herein relate to a device. The device may include one or more memories and one or more processors coupled to the one or more memories. The one or more processors may be configured to receive scenario data identifying a scenario for enterprise resource planning that includes a base solution and processes and generate an output file based on the scenario data. The one or more processors may be configured to generate a hierarchy for the scenario based on the output file and identify prerequisites for the scenario based on the output file. The one or more processors may be configured to generate configurations and test scripts for the scenario based on the hierarchy and the prerequisites and activate the configurations and the test scripts. The one or more processors may be configured to retrieve, from a data structure associated with the device, master data associated with the configurations and the test scripts and process the configurations, the test scripts, and the master data, with a machine learning model, to predict a risk severity associated with the scenario. The one or more processors may be configured to perform one or more actions based on the risk severity associated with the scenario.

Some implementations described herein relate to a non-transitory computer-readable medium that stores a set of instructions for a device. The set of instructions, when executed by one or more processors of the device, may cause the device to receive scenario data identifying a scenario for enterprise resource planning that includes a base solution and processes and generate an output file based on the scenario data. The set of instructions, when executed by one or more processors of the device, may cause the device to generate a hierarchy for the scenario based on the output file and identify prerequisites for the scenario based on the output file. The set of instructions, when executed by one or more processors of the device, may cause the device to generate configurations and test scripts for the scenario based on the hierarchy and the prerequisites and activate the configurations and the test scripts. The set of instructions, when executed by one or more processors of the device, may cause the device to retrieve, from a data structure associated with the device, master data associated with the configurations and the test scripts and load the master data for the configurations and the test scripts. The set of instructions, when executed by one or more processors of the device, may cause the device to process the configurations, the test scripts, and the master data, with a machine learning model, to predict a risk severity associated with the scenario and perform one or more actions based on the risk severity associated with the scenario.

### BRIEF DESCRIPTION OF THE DRAWINGS

FIGS. 1A-1F are diagrams of an example implementation described herein.

FIG. 2 is a diagram illustrating an example of training and using a machine learning model in connection with identifying a risk severity for an enterprise resource planning scenario.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing a machine learning model to identify a risk severity for an enterprise resource planning scenario.

### DETAILED DESCRIPTION

The following detailed description of example implementations refers to the accompanying drawings. The same reference numbers in different drawings may identify the same or similar elements.

Enterprise resource planning may be performed with management software, such as a set of integrated applications. The set of integrated applications enables an entity (e.g., a business, an organization, and/or the like) to collect, store, manage, and interpret data from many entity activities. Many entities face the challenge of digitally transforming and consolidating the applications of enterprise resource planning systems. However, current techniques for digitally transforming and consolidating enterprise resource planning systems require significant resources and may generate incomplete enterprise resource planning systems, inoperable enterprise resource planning systems, and/or the like. Therefore, current techniques for digitally transforming and consolidating enterprise resource planning systems consume computing resources (e.g., processing resources, memory resources, communication resources, and/or the like), networking resources, and/or the like associated with generating defective or inoperable enterprise resource planning systems, utilizing the defective or inoperable enterprise resource planning systems, correcting the defective or inoperable enterprise resource planning systems, and/or the like.

Some implementations described herein relate to a process composer system that utilizes a machine learning model to identify a risk severity for an enterprise resource planning scenario. For example, the process composer system may receive scenario data identifying a scenario for enterprise resource planning that includes a base solution and processes, and may generate an output file based on the scenario data. The process composer system may generate a hierarchy for the scenario based on the output file and may identify prerequisites for the scenario based on the output file. The process composer system may generate configurations and test scripts for the scenario based on the hierarchy and the prerequisites, and may retrieve, from a data structure associated with the device, master data associated with the configurations and the test scripts. The process composer system may process the configurations, the test scripts, and the master data, with a machine learning model, to predict a risk severity associated with the scenario, and may perform one or more actions based on the risk severity associated with the scenario.

In this way, the process composer system utilizes a machine learning model to identify a risk severity for an enterprise resource planning scenario. The process composer system may generate an output file that includes a list of scenarios (e.g., enterprise resource planning scenarios) selected by a user, and may identify configurations and test scripts for the scenarios. The process composer system may activate the configurations and the test scripts for the scenarios, and may retrieve master data for the configurations and the test scripts. The process composer system may process the configurations, the test scripts, and the master data, with a machine learning model, to calculate risk severities for the scenarios, and may present the risk severities to the user. This, in turn, conserves computing resources, networking resources, and/or the like that would otherwise have been consumed in generating defective or inoperable enterprise resource planning systems, utilizing the defective or inoperable enterprise resource planning systems, correcting the defective or inoperable enterprise resource planning systems, and/or the like.

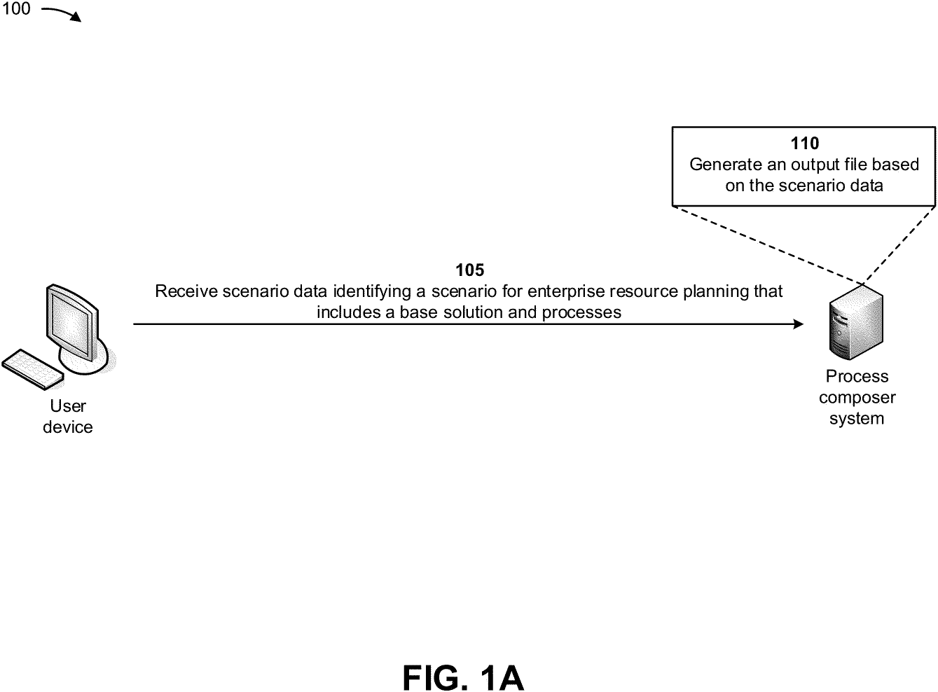

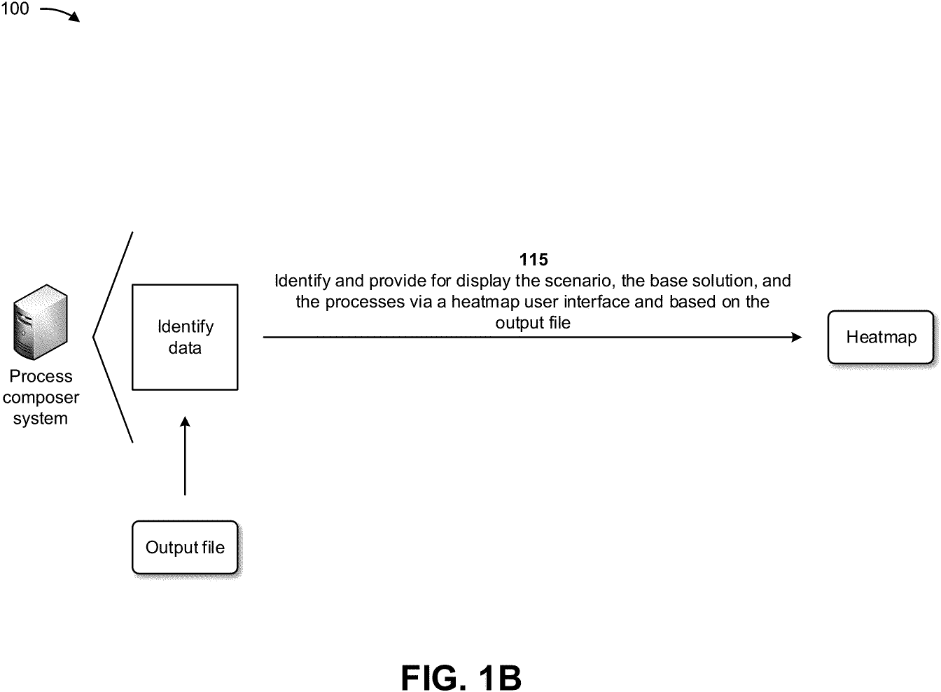

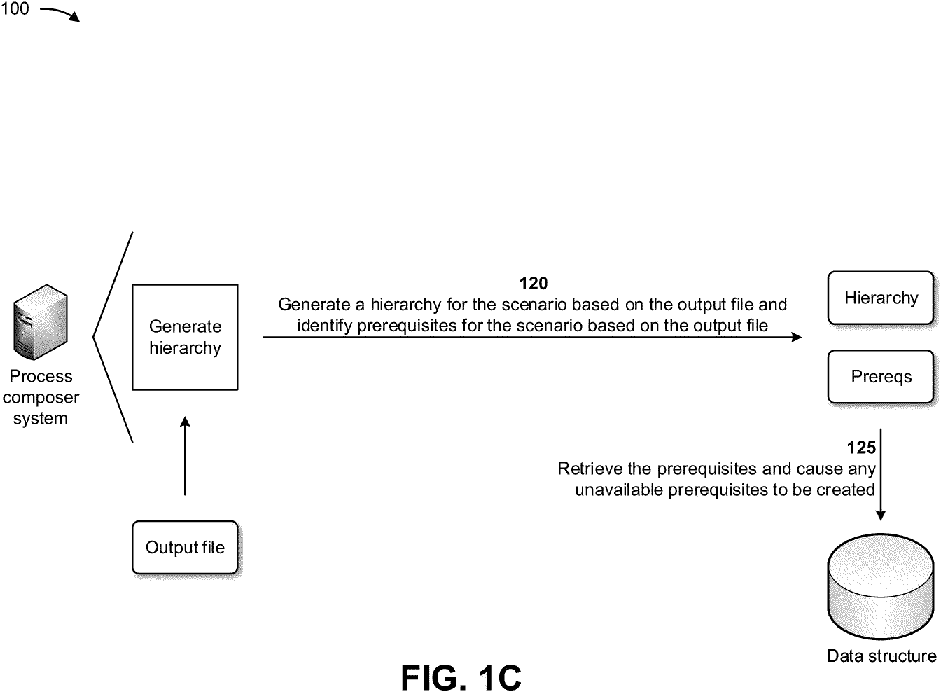

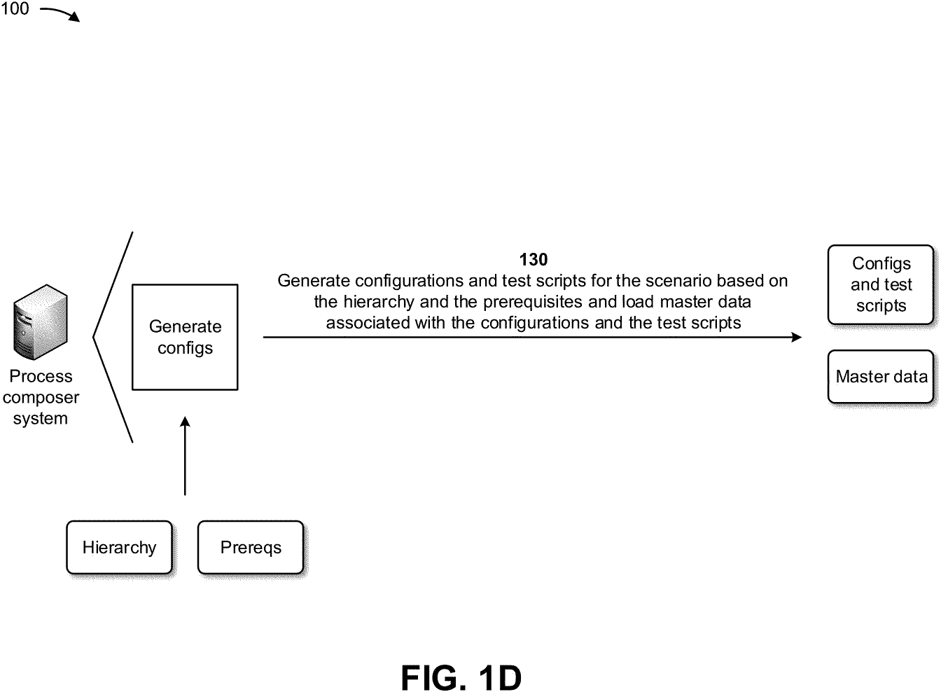

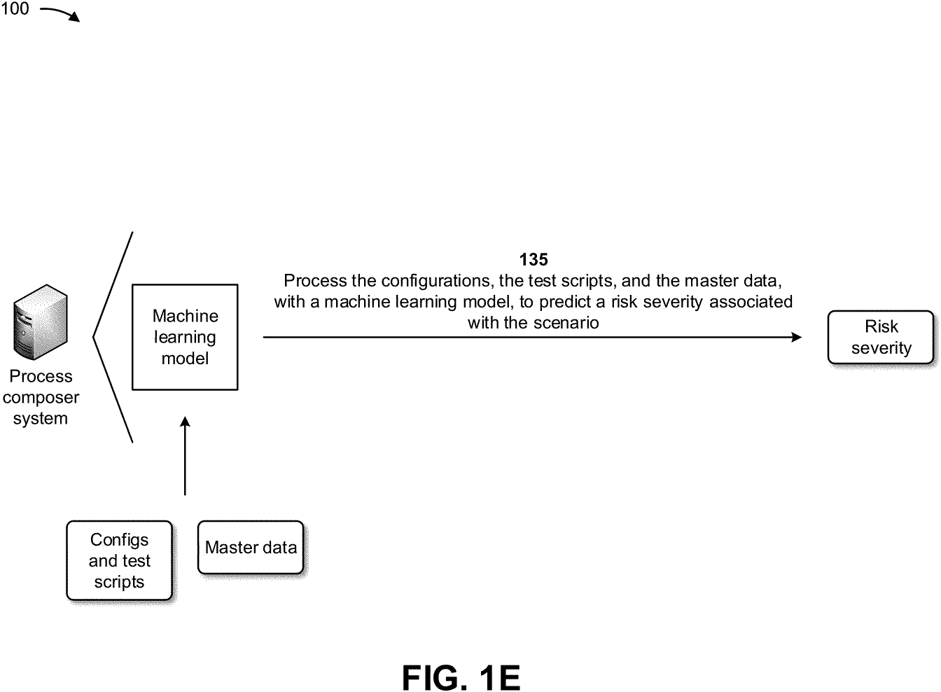

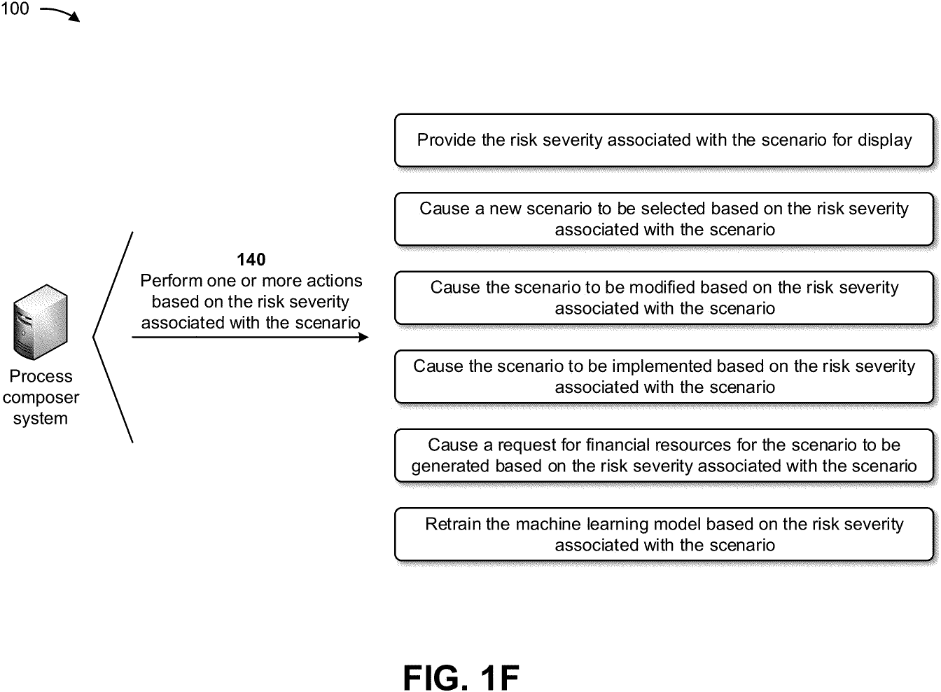

FIGS. 1A-1F are diagrams of an example 100 associated with utilizing a machine learning model to identify a risk severity for an enterprise resource planning scenario. As shown in FIGS. 1A-1F, example 100 includes a user device and a process composer system. The user device may include a wireless communication device, a mobile phone, a user equipment, a laptop computer, a tablet computer, and/or the like. The process composer system may include a system that utilizes a machine learning model to identify a risk severity for an enterprise resource planning scenario. Further details of the user device and the process composer system are provided elsewhere herein.

As shown in FIG. 1A, and by reference number 105, the process composer system may receive scenario data identifying a scenario for enterprise resource planning that includes a base solution and processes. For example, a user may provide data identifying processes (e.g., business processes, manufacturing processes, finance processes, and/or the like) and a base solution for enterprise resource planning to the user device. The data identifying the processes and the base solution may constitute the scenario data. The user device may provide the scenario data to the process composer system, and the process composer system may receive the scenario data. In some implementations, the process composer system may provide option data identifying processes and base solutions across different industries to the user device, and the user device may provide the option data for display to the user. The user may select one or more processes and/or base solutions from the option data, and the user device may provide data identifying the selected one or more processes and/or base solutions to the process composer system. In some implementations, the process composer system may receive, from the user device, scenario data identifying a plurality of scenarios for enterprise resource planning.

As further shown in FIG. 1A, and by reference number 110, the process composer system may generate an output file based on the scenario data. For example, the process composer system may generate an output file in a particular format (e.g., an Extensible Markup Language (XML) format) based on the scenario data. The output file may include data identifying the scenario, the base solution, the processes, an industry associated with the scenario, one or more modules associated with the scenario, and/or the like. In some implementations, the output file may include data identifying other scenarios selected by the user via the user device.

As shown in FIG. 1B, and by reference number 115, the process composer system may identify and provide for display the scenario, the base solution, and the processes via a heatmap user interface and based on the output file. For example, the process composer system may read (e.g., via an XML reader) the output file and may identify the scenario, the base solution, and the processes based on reading the output file. In some implementations, the process composer system may identify the other scenarios selected by the user via the user device. The process composer system may generate the heatmap user interface based on the identified scenario, base solution, processes, other scenarios, and/or the like. The heatmap user interface may display scenarios associated with the base solution (e.g., a base industry) first, followed by scenarios of other industries. For example, the heatmap user interface may display the scenario first since the scenario is associated with the base solution. The process composer system may provide the heatmap user interface for display to the user device, and the user device may display the heatmap user interface to the user. In this way, the user may easily identify which scenarios are associated with which industries.

As shown in FIG. 1C, and by reference number 120, the process composer system may generate a hierarchy for the scenario based on the output file and may identify prerequisites for the scenario based on the output file. For example, the process composer system may generate a hierarchy for the scenario based on mobile solutions, addons, business functions, and/or the like associated with the scenario. The hierarchy may include a tree structure with a mobile solution node, an addon parent node, a business function parent node, and/or the like. The mobile solutions, the addons, the business functions, and/or the like may be listed under corresponding parent nodes in the tree structure. In some implementations, the process composer system may utilize a subroutine and/or a table to identify the mobile solutions for the scenario, to identify the addons for the scenario, to identify the business functions for the scenario, and/or the like. In some implementations, when generating the hierarchy for the scenario based on the output file, the process composer system may identify the mobile solutions for the scenario based on the output file and may identify the addons for the scenario based on the output file. The process composer system may identify the business functions for the scenario based on the output file, and may generate the hierarchy for the scenario based on the mobile solutions, the addons, and the business functions for the scenario.

In some implementations, the process composer system may identify the prerequisites for the scenario by identifying prerequisites for the mobile solutions, prerequisites for the addons, prerequisites for the business functions, and/or the like.

As further shown in FIG. 1C, and by reference number 125, the process composer system may retrieve the prerequisites and cause any unavailable prerequisites to be created. For example, the process composer system may retrieve the prerequisites for the mobile solutions, the prerequisites for the addons, the prerequisites for the business functions, and/or the like from a data structure (e.g., a database, a table, a list, and/or the like) associated with the process composer system. If a prerequisite is unavailable (e.g., not stored in the data structure), the process composer system may cause the unavailable prerequisite to be created. For example, the process composer system may provide, to the user device, instructions for creating the unavailable prerequisite. The user device may display the instructions to the user and the user may create the unavailable prerequisite based on the instructions.

As shown in FIG. 1D, and by reference number 130, the process composer system may generate configurations and test scripts for the scenario based on the hierarchy and the prerequisites, and may load master data associated with the configurations and the test scripts. For example, the process composer system may generate configurations for the mobile solutions, configurations for the addons, configurations for the business functions, and/or the like of the scenario based on the hierarchy and the prerequisites. The process composer system may also generate test scripts for the mobile solutions, test scripts for the addons, test scripts for the business functions, and/or the like of the scenario based on the hierarchy and the prerequisites. The configurations may be utilized to create and configure the mobile solutions, the prerequisites for the addons, the prerequisites for the business functions, and/or the like of the scenario. The test scripts may be utilized to test the mobile solutions, the prerequisites for the addons, the prerequisites for the business functions, and/or the like after the mobile solutions, the prerequisites for the addons, the prerequisites for the business functions, and/or the like are created and configured.

The process composer system may identify the master data associated with the configurations and the test scripts in the data structure associated with the process composer system. The process composer system may retrieve the master data associated with the configurations and the test scripts from the data structure based on identifying the master data in the data structure. The process composer system may load (e.g., populate) the configurations and the test scripts with corresponding retrieved master data based on identifying the master data in the data structure. For example, the process composer system may utilize one or more template files (e.g., XML template files) to load the configurations and the test scripts with corresponding retrieved master data. In some implementations, the master data includes data identifying one or more of historic test execution status, transaction coverage count, module-based priority, unselected duplicate test cases, order type coverage, and/or the like.

As shown in FIG. 1E, and by reference number 135, the process composer system may process the configurations, the test scripts, and the master data, with a machine learning model, to predict a risk severity associated with the scenario. In some implementations, the process composer system may activate the configurations and the test scripts prior to processing the configurations, the test scripts, and the master data with the machine learning model. In some implementations, the process composer system may load the master data for the configurations and the test scripts prior to processing the configurations, the test scripts, and the master data with the machine learning model and/or prior to activating the configurations and the test scripts.

In some implementations, the machine learning model includes a classification machine learning model. When processing the configurations, the test scripts, and the master data, with the machine learning model, to predict the risk severity associated with the scenario, the process composer system (e.g., via the machine learning model) may execute the configurations and the test scripts with the master data to generate execution results and may predict the risk severity associated with the scenario based on the execution results. The risk severity may include a complexity associated with the scenario, an impact analysis (e.g., dependencies) associated with the scenario, and/or the like.

In some implementations, the process composer system may cause the machine learning model to predict the risk severity associated with the scenario by extracting required data from the master data (e.g., historic test execution status, transaction coverage count, module-based priority, unselected duplicate test cases, order type coverage, and/or the like). The process composer system may cause the machine learning model to process the extracted master data with the test scripts using regular expressions and other tools. If the machine learning model processes multiple scenarios, the machine learning model may provide one or more recommended scenarios from the multiple scenarios based on risk severities determined for the multiple scenarios. The user of the user device may accept or reject one or more of the recommended scenarios. If the user accepts one or more of the recommended scenarios, the process composer system may add corresponding test scripts for testing the one or more of the recommended scenarios. The process composer system may execute the corresponding test scripts for the one or more of the recommended scenarios and may publish test results based on executing the corresponding test scripts. The process composer system may utilize the test results to retrain the machine learning model.

As shown in FIG. 1F, and by reference number 135, the process composer system may perform one or more actions based on the risk severity associated with the scenario. In some implementations, the one or more actions include the process composer system providing the risk severity associated with the scenario for display. For example, the process composer system may provide the risk severity associated with the scenario for display to an operator of the process composer system, to a chief information officer of the entity, to information operators of the entity, and/or the like. Such parties may utilize the risk severity associated with the scenario for different purposes. For example, the chief information security officer may present the risk severity associated with the scenario to executives of the entity so that the executives may be convinced to allocate resources for the scenario associated with the risk severity. In this way, the process composer system may conserve computing resources, networking resources, and/or the like that would otherwise have been consumed in generating defective or inoperable enterprise resource planning systems, utilizing the defective or inoperable enterprise resource planning systems, correcting the defective or inoperable enterprise resource planning systems, and/or the like.

In some implementations, the one or more actions include the process composer system causing a new scenario to be selected based on the risk severity associated with the scenario. For example, the process composer system may determine that the risk severity fails to satisfy a threshold for the scenario to not be at risk of being defective or rendered inoperable. The process composer system may determine a new scenario so that the risk severity associated with the new scenario satisfies the threshold. The process composer system may cause the new scenario to be implemented (e.g., generating a consolidated enterprise resource system). In this way, the process composer system may conserve computing resources, networking resources, and/or the like that would otherwise have been consumed in generating defective or inoperable enterprise resource planning systems, utilizing the defective or inoperable enterprise resource planning systems, correcting the defective or inoperable enterprise resource planning systems after implementation, and/or the like.

In some implementations, the one or more actions include the process composer system causing the scenario to be modified based on the risk severity associated with the scenario. For example, the process composer system may determine that the risk severity fails to satisfy the threshold for the scenario to not be at risk of being defective or rendered inoperable. The process composer system may determine one or more features associated with the scenario that may be modified so that the risk severity associated with the modified scenario satisfies the threshold. The process composer system may cause the one or more features of the scenario to be modified so that the scenario may be successfully implemented. In this way, the process composer system may conserve computing resources, networking resources, and/or the like that would otherwise have been consumed in generating defective or inoperable enterprise resource planning systems, utilizing the defective or inoperable enterprise resource planning systems, correcting the defective or inoperable enterprise resource planning systems after implementation, and/or the like.

In some implementations, the one or more actions include the process composer system causing the scenario to be implemented based on the risk severity associated with the scenario. For example, the process composer system may determine that the risk severity satisfies the threshold for the scenario to not be at risk of being defective or rendered inoperable. Thus, the process composer system may cause the entity to implement the scenario. In this way, the process composer system may conserve computing resources, networking resources, and/or the like that would otherwise have been consumed in generating defective or inoperable enterprise resource planning systems, utilizing the defective or inoperable enterprise resource planning systems, and/or the like.

In some implementations, the one or more actions include the process composer system causing a request for financial resources for the scenario to be generated based on the risk severity associated with the scenario. For example, the process composer system may determine that the risk severity satisfies the threshold for the scenario to not be at risk of being defective or rendered inoperable. The process composer system may generate a request for financial resources for the scenario so that the scenario may be implemented with the financial resources. In this way, the process composer system may conserve computing resources, networking resources, and/or the like that would otherwise have been consumed in generating defective or inoperable enterprise resource planning systems, utilizing the defective or inoperable enterprise resource planning systems, and/or the like.

In some implementations, the one or more actions include the process composer system retraining the machine learning model based on the risk severity associated with the scenario. The process composer system may utilize the risk severity as additional training data for retraining the machine learning model, thereby increasing the quantity of training data available for training the machine learning model. Accordingly, the process composer system may conserve computing resources associated with identifying, obtaining, and/or generating historical data for training the machine learning model relative to other systems for identifying, obtaining, and/or generating historical data for training machine learning models.

In this way, the process composer system utilizes a machine learning model to identify a risk severity for an enterprise resource planning scenario. The process composer system may generate an output file that includes a list of scenarios (e.g., enterprise resource planning scenarios) selected by a user, and may identify configurations and test scripts for the scenarios. The process composer system may activate the configurations and the test scripts for the scenarios and may retrieve master data for the configurations and the test scripts. The process composer system may process the configurations, the test scripts, and the master data, with the machine learning model, to calculate risk severities for the scenarios, and may present the risk severities to the user. This, in turn, conserves computing resources, networking resources, and/or the like that would otherwise have been consumed in generating defective or inoperable enterprise resource planning systems, utilizing the defective or inoperable enterprise resource planning systems, correcting the defective or inoperable enterprise resource planning systems, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

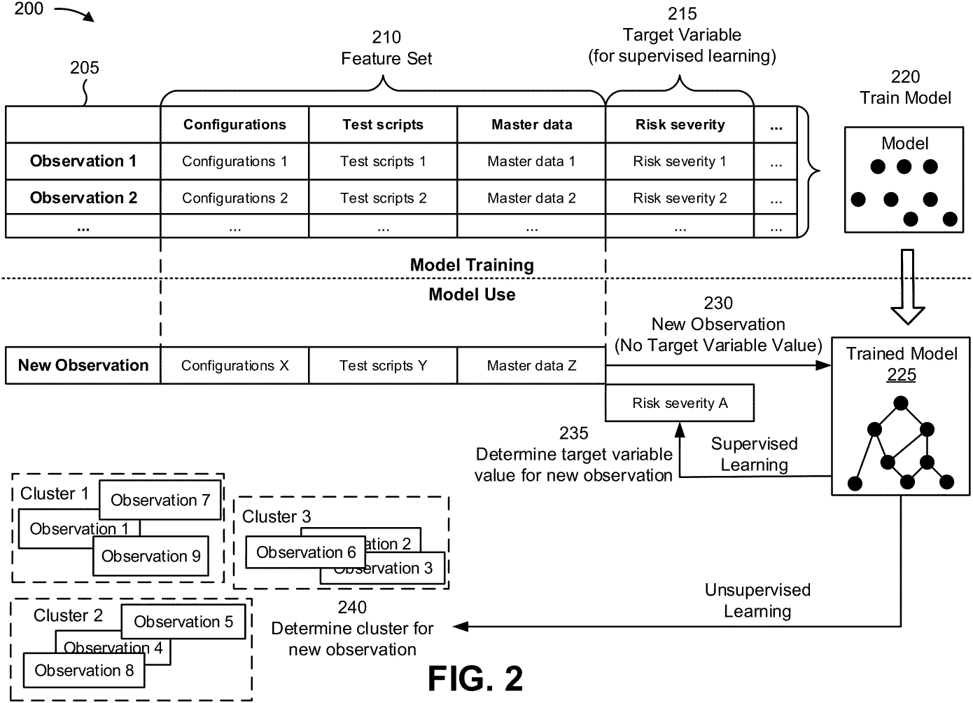

FIG. 2 is a diagram illustrating an example 200 of training and using a machine learning model in connection with identifying a risk severity for an enterprise resource planning scenario. The machine learning model training and usage described herein may be performed using a machine learning system. The machine learning system may include or may be included in a computing device, a server, a cloud computing environment, and/or the like, such as the process composer system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the process composer system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the process composer system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of configurations, a second feature of test scripts, a third feature of master data, and so on. As shown, for a first observation, the first feature may have a value of configurations 1, the second feature may have a value of test scripts 1, the third feature may have a value of master data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable is a risk severity, which has a value of risk severity 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of configurations X, a second feature of test scripts Y, a third feature of master data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of risk severity A for the target variable of the risk severity for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a configurations cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a test scripts cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to identify a risk severity for an enterprise resource planning scenario. The machine learning system enables recognition and/or identification of tens, hundreds, thousands, or millions of features and/or feature values for tens, hundreds, thousands, or millions of observations, thereby increasing accuracy and consistency and reducing delay associated with identifying a risk severity for an enterprise resource planning scenario relative to requiring computing resources to be allocated for tens, hundreds, or thousands of operators to manually identify a risk severity for an enterprise resource planning scenario.

As indicated above, FIG. 2 is provided as an example. Other examples may differ from what is described in connection with FIG. 2.

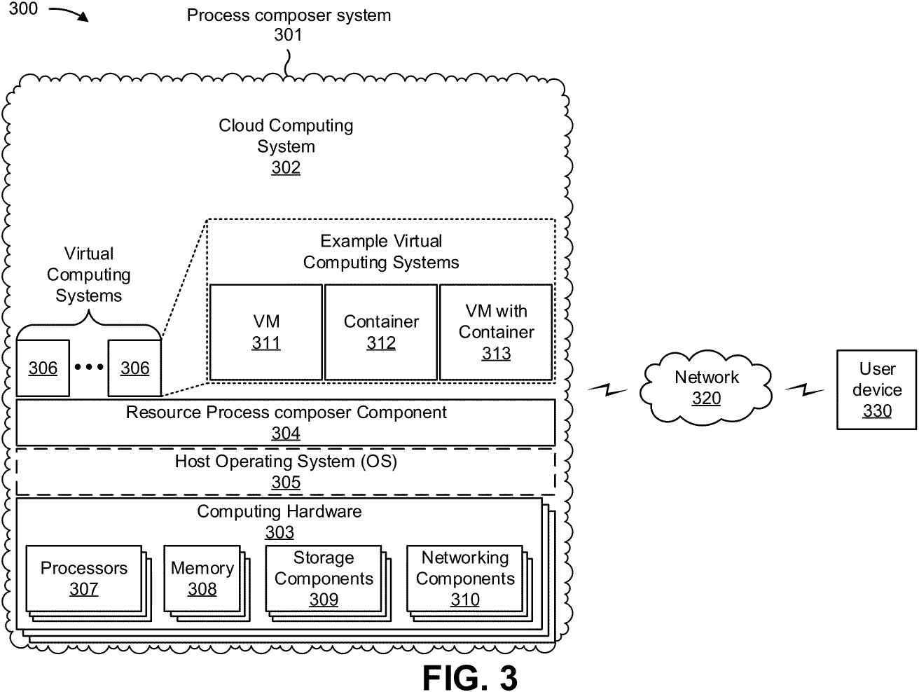

FIG. 3 is a diagram of an example environment 300 in which systems and/or methods described herein may be implemented. As shown in FIG. 3, the environment 300 may include a process composer system 301, which may include one or more elements of and/or may execute within a cloud computing system 302. The cloud computing system 302 may include one or more elements 303-313, as described in more detail below. As further shown in FIG. 3, the environment 300 may include a network 320 and/or a user device 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

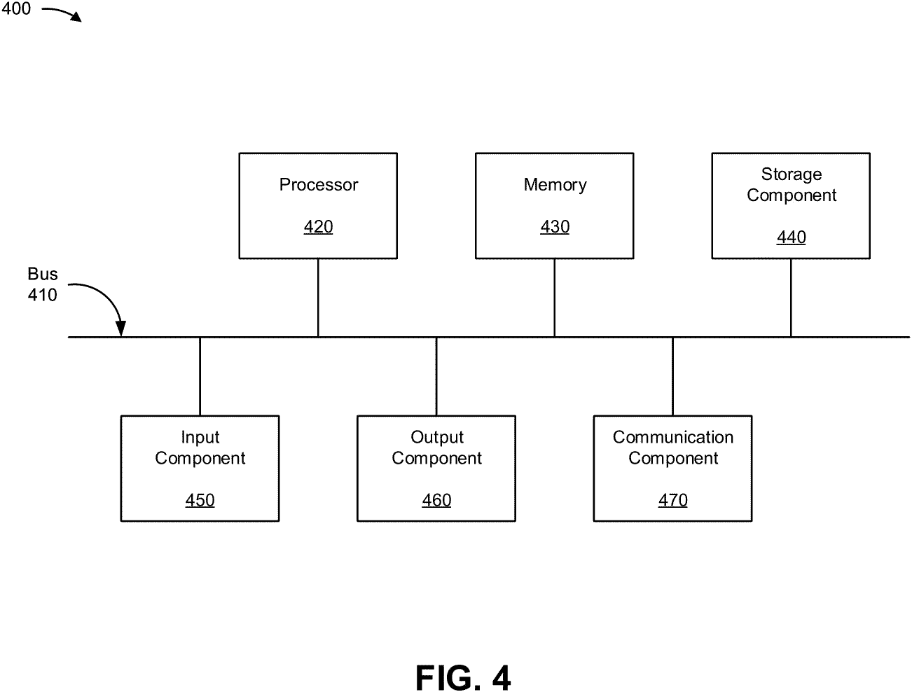

Although the process composer system 301 may include one or more elements 303-313 of the cloud computing system 302, may execute within the cloud computing system 302, and/or may be hosted within the cloud computing system 302, in some implementations, the process composer system 301 may not be cloud-based (e.g., may be implemented outside of a cloud computing system) or may be partially cloud-based. For example, the process composer system 301 may include one or more devices that are not part of the cloud computing system 302, such as device 400 of FIG. 4, which may include a standalone server or another type of computing device. The process composer system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The user device 330 includes one or more devices capable of receiving, generating, storing, processing, and/or providing information, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the process composer system 301 and/or the user device 330. In some implementations, the process composer system 301 and/or the user device 330 may include one or more devices 400 and/or one or more components of the device 400. As shown in FIG. 4, the device 400 may include a bus 410, a processor 420, a memory 430, a storage component 440, an input component 450, an output component 460, and a communication component 470.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The storage component 440 stores information and/or software related to the operation of the device 400. For example, the storage component 440 may include a hard disk drive, a magnetic disk drive, an optical disk drive, a solid-state disk drive, a compact disc, a digital versatile disc, and/or another type of non-transitory computer-readable medium. The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, an actuator, and/or the like. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, an antenna, and/or the like.

The device 400 may perform one or more processes described herein. For example, a non-transitory computer-readable medium (e.g., the memory 430 and/or the storage component 440) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

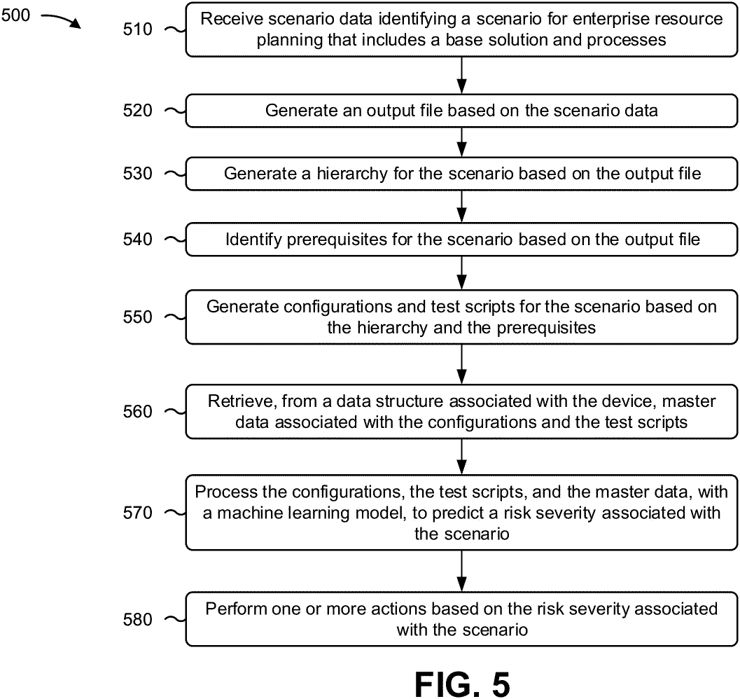

FIG. 5 is a flowchart of an example process 500 for utilizing a machine learning model to identify a risk severity for an enterprise resource planning scenario. In some implementations, one or more process blocks of FIG. 5 may be performed by a device (e.g., the process composer system 301). In some implementations, one or more process blocks of FIG. 5 may be performed by another device or a group of devices separate from or including the device, such as a user device (e.g., the user device 330). Additionally, or alternatively, one or more process blocks of FIG. 5 may be performed by one or more components of the device 400, such as the processor 420, the memory 430, the storage component 440, the input component 450, the output component 460, and/or the communication component 470.

As shown in FIG. 5, process 500 may include receiving scenario data identifying a scenario for enterprise resource planning that includes a base solution and processes (block 510). For example, the device may receive scenario data identifying a scenario for enterprise resource planning that includes a base solution and processes, as described above.

As further shown in FIG. 5, process 500 may include generating an output file based on the scenario data (block 520). For example, the device may generate an output file based on the scenario data, as described above.

As further shown in FIG. 5, process 500 may include generating a hierarchy for the scenario based on the output file (block 530). For example, the device may generate a hierarchy for the scenario based on the output file, as described above. In some implementations, generating the hierarchy for the scenario based on the output file includes identifying mobile solutions for the scenario based on the output file, identifying addons for the scenario based on the output file, identifying business functions for the scenario based on the output file, and generating the hierarchy for the scenario based on the mobile solutions, the addons, and the business functions for the scenario.

As further shown in FIG. 5, process 500 may include identifying prerequisites for the scenario based on the output file (block 540). For example, the device may identify prerequisites for the scenario based on the output file, as described above.

As further shown in FIG. 5, process 500 may include generating configurations and test scripts for the scenario based on the hierarchy and the prerequisites (block 550). For example, the device may generate configurations and test scripts for the scenario based on the hierarchy and the prerequisites, as described above.

As further shown in FIG. 5, process 500 may include retrieving, from a data structure associated with the device, master data associated with the configurations and the test scripts (block 560). For example, the device may retrieve, from a data structure associated with the device, master data associated with the configurations and the test scripts, as described above. In some implementations, the master data includes data identifying one or more of historic test execution status, transaction coverage count, module-based priority, unselected duplicate test cases, or order type coverage.

As further shown in FIG. 5, process 500 may include processing the configurations, the test scripts, and the master data, with a machine learning model, to predict a risk severity associated with the scenario (block 570). For example, the device may process the configurations, the test scripts, and the master data, with a machine learning model, to predict a risk severity associated with the scenario, as described above. In some implementations, the machine learning model includes a classification model. In some implementations, processing the configurations, the test scripts, and the master data, with the machine learning model, to predict the risk severity associated with the scenario includes executing the configurations and the test scripts with the master data to generate execution results, and predicting the risk severity associated with the scenario based on the execution results.

As further shown in FIG. 5, process 500 may include performing one or more actions based on the risk severity associated with the scenario (block 580). For example, the device may perform one or more actions based on the risk severity associated with the scenario, as described above. In some implementations, performing the one or more actions based on the risk severity associated with the scenario, includes one or more of providing the risk severity associated with the scenario for display, causing a new scenario to be selected based on the risk severity associated with the scenario, or causing the scenario to be modified based on the risk severity associated with the scenario.

In some implementations, performing the one or more actions based on the risk severity associated with the scenario includes one or more of causing the scenario to be implemented based on the risk severity associated with the scenario, causing a request for financial resources for the scenario to be generated based on the risk severity associated with the scenario, or retraining the machine learning model based on the risk severity associated with the scenario.

In some implementations, performing the one or more actions based on the risk severity associated with the scenario includes determining that the risk severity associated with the scenario fails to satisfy a threshold severity level, selecting a new scenario based on determining that the risk severity fails to satisfy the threshold severity level, and processing the new scenario to determine whether a new risk severity associated with the new scenario satisfies the threshold severity level.

In some implementations, performing the one or more actions based on the risk severity associated with the scenario includes determining that the risk severity associated with the scenario fails to satisfy a threshold severity level; modifying the scenario, to generate a modified scenario, based on determining that the risk severity fails to satisfy the threshold severity level; and processing the modified scenario to determine whether a modified risk severity associated with the modified scenario satisfies the threshold severity level.

Process 500 may include additional implementations, such as any single implementation or any combination of implementations described below and/or in connection with one or more other processes described elsewhere herein.

In some implementations, process 500 includes identifying the scenario, the base solution, and the processes based on the output file; generating a heatmap user interface that includes data identifying the scenario, the base solution, the processes, and an industry associated with the scenario; and providing the heatmap user interface for display.

In some implementations, process 500 includes retrieving the prerequisites from the data structure associated with the device, and causing the prerequisites not provided in the data structure to be created. In some implementations, process 500 includes activating the configurations and the test scripts prior to processing the configurations, the test scripts, and the master data with the machine learning model. In some implementations, process 500 includes loading the master data for the configurations and the test scripts prior to processing the configurations, the test scripts, and the master data with the machine learning model.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a" and “an" are intended to include one or more items and may be used interchangeably with “one or more." Further, as used herein, the article “the" is intended to include one or more items referenced in connection with the article “the" and may be used interchangeably with “the one or more." Furthermore, as used herein, the term “set" is intended to include one or more items (e.g., related items, unrelated items, a combination of related and unrelated items, and/or the like), and may be used interchangeably with “one or more." Where only one item is intended, the phrase “only one" or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of').

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, scenario data identifying a scenario for enterprise resource planning that includes a base solution and processes;
generating, by the device, an output file based on the scenario data;
generating, by the device, a hierarchy for the scenario based on the output file;
identifying, by the device, prerequisites for the scenario based on the output file;
generating, by the device, configurations and test scripts for the scenario based on the hierarchy and the prerequisites;
retrieving, by the device and from a data structure associated with the device, master data associated with the configurations and the test scripts;
processing, by the device, the configurations, the test scripts, and the master data, with a machine learning model, to predict a risk severity associated with the scenario; and
performing, by the device, one or more actions based on the risk severity associated with the scenario.

2. The method of claim 1, further comprising:
identifying the scenario, the base solution, and the processes based on the output file;
generating a heatmap user interface that includes data identifying the scenario, the base solution, the processes, and an industry associated with the scenario; and
providing the heatmap user interface for display.

3. The method of claim 1, further comprising:
retrieving the prerequisites from the data structure associated with the device; and
causing the prerequisites not provided in the data structure to be created.

4. The method of claim 1, wherein generating the hierarchy for the scenario based on the output file comprises:
identifying mobile solutions for the scenario based on the output file;
identifying addons for the scenario based on the output file;
identifying business functions for the scenario based on the output file; and
generating the hierarchy for the scenario based on the mobile solutions, the addons, and the business functions for the scenario.

5. The method of claim 1, further comprising:
activating the configurations and the test scripts prior to processing the configurations, the test scripts, and the master data with the machine learning model.

6. The method of claim 1, further comprising:
loading the master data for the configurations and the test scripts prior to processing the configurations, the test scripts, and the master data with the machine learning model.

7. The method of claim 1, wherein the machine learning model includes a classification model.

8. A device, comprising:
one or more memories; and
one or more processors, coupled to the one or more memories, configured to:
receive scenario data identifying a scenario for enterprise resource planning that includes a base solution and processes;
generate an output file based on the scenario data;
generate a hierarchy for the scenario based on the output file;
identify prerequisites for the scenario based on the output file;
generate configurations and test scripts for the scenario based on the hierarchy and the prerequisites;
activate the configurations and the test scripts;
retrieve, from a data structure associated with the device, master data associated with the configurations and the test scripts;
process the configurations, the test scripts, and the master data, with a machine learning model, to predict a risk severity associated with the scenario; and
perform one or more actions based on the risk severity associated with the scenario.

9. The device of claim 8, wherein the one or more processors, to process the configurations, the test scripts, and the master data, with the machine learning model, to predict the risk severity associated with the scenario, are configured to:
execute the configurations and the test scripts with the master data to generate execution results; and
predict the risk severity associated with the scenario based on the execution results.

10. The device of claim 8, wherein the one or more processors, to perform the one or more actions based on the risk severity associated with the scenario, are configured to one or more of:
provide the risk severity associated with the scenario for display;
cause a new scenario to be selected based on the risk severity associated with the scenario; or
cause the scenario to be modified based on the risk severity associated with the scenario.

11. The device of claim 8, wherein the one or more processors, to perform the one or more actions based on the risk severity associated with the scenario, are configured to one or more of:
cause the scenario to be implemented based on the risk severity associated with the scenario;
cause a request for financial resources for the scenario to be generated based on the risk severity associated with the scenario; or
retrain the machine learning model based on the risk severity associated with the scenario.

12. The device of claim 8, wherein the one or more processors, to perform the one or more actions based on the risk severity associated with the scenario, are configured to:
determine that the risk severity associated with the scenario fails to satisfy a threshold severity level;
select a new scenario based on determining that the risk severity fails to satisfy the threshold severity level; and
process the new scenario to determine whether a new risk severity associated with the new scenario satisfies the threshold severity level.

13. The device of claim 8, wherein the one or more processors, to perform the one or more actions based on the risk severity associated with the scenario, are configured to:
determine that the risk severity associated with the scenario fails to satisfy a threshold severity level;
modify the scenario, to generate a modified scenario, based on determining that the risk severity fails to satisfy the threshold severity level; and
process the modified scenario to determine whether a modified risk severity associated with the modified scenario satisfies the threshold severity level.

14. The device of claim 8, wherein the master data includes data identifying one or more of:
historic test execution status,
transaction coverage count,
module-based priority,
unselected duplicate test cases, or
order type coverage.

15. A non-transitory computer-readable medium storing a set of instructions, the set of instructions comprising:
one or more instructions that, when executed by one or more processors of a device, cause the device to:
receive scenario data identifying a scenario for enterprise resource planning that includes a base solution and processes;
generate an output file based on the scenario data;
generate a hierarchy for the scenario based on the output file;
identify prerequisites for the scenario based on the output file;
generate configurations and test scripts for the scenario based on the hierarchy and the prerequisites;
activate the configurations and the test scripts;
retrieve, from a data structure associated with the device, master data associated with the configurations and the test scripts;
load the master data for the configurations and the test scripts;
process the configurations, the test scripts, and the master data, with a machine learning model, to predict a risk severity associated with the scenario; and
perform one or more actions based on the risk severity associated with the scenario.

16. The non-transitory computer-readable medium of claim 15, wherein the one or more instructions further cause the device to:
identify the scenario, the base solution, and the processes based on the output file;
generate a heatmap user interface that includes data identifying the scenario, the base solution, the processes, and an industry associated with the scenario; and
provide the heatmap user interface for display.

17. The non-transitory computer-readable medium of claim 15, wherein the one or more instructions further cause the device to:
retrieve the prerequisites from the data structure associated with the device; and
cause the prerequisites not provided in the data structure to be created.

18. The non-transitory computer-readable medium of claim 15, wherein the one or more instructions, that cause the device to generate the hierarchy for the scenario based on the output file, cause the device to:
identify mobile solutions for the scenario based on the output file;
identify addons for the scenario based on the output file;
identify business functions for the scenario based on the output file; and
generate the hierarchy for the scenario based on the mobile solutions, the addons, and the business functions for the scenario.

19. The non-transitory computer-readable medium of claim 15, wherein the one or more instructions, that cause the device to process the configurations, the test scripts, and the master data, with the machine learning model, to predict the risk severity associated with the scenario, cause the device to:
execute the configurations and the test scripts with the master data to generate execution results; and
predict the risk severity associated with the scenario based on the execution results.

20. The non-transitory computer-readable medium of claim 15, wherein the one or more instructions, that cause the device to perform the one or more actions based on the risk severity associated with the scenario, cause the device to one or more of:
provide the risk severity associated with the scenario for display;
cause a new scenario to be selected based on the risk severity associated with the scenario;
cause the scenario to be modified based on the risk severity associated with the scenario;
cause the scenario to be implemented based on the risk severity associated with the scenario;
cause a request for financial resources for the scenario to be generated based on the risk severity associated with the scenario; or
retrain the machine learning model based on the risk severity associated with the scenario.
